(19) United States
(12) Patent Application Publication
(10) Pub. No.: US 2015/0260532 A1
(43) Pub. Date: Sep. 17, 2015

(54) SYSTEMS AND METHODS FOR UPDATING MAP INFORMATION USING LOCAL DRIVER INPUT

(71) Applicant: Google Inc., Mountain View, CA (US)

(72) Inventors: Jason Robert Richard Sanio, Mountain View, CA (US); Courtney Hampson, Mountain View, CA (US)

(73) Assignee: GOOGLE INC., Mountain View, CA (US)

(21) Appl. No.: 14/206,188

(22) Filed: Mar. 12, 2014

(51) Int. Cl. G01C 21/34

(52) U.S. Cl. CPC G01C 21/34

(57) ABSTRACT

Aspects of the present disclosure relate generally to determining whether a given user is a local or knowledgeable driver of a given area and using their driving habits, routes and other factors to improve mapping recommendations in real-time. For example, paths traveled within the given area by a driver are weighted based on the driver's level of knowledge of the given area. Based on the weight, the paths traveled by the driver may be used to update map information, replace suggested routes of travel, or the like.

### BACKGROUND

Users of navigation devices and services become frustrated when a digital map does not offer the best route to a given destination. For example, sometimes a navigation device will instruct a user to make an impossible turn, or will guide a user along a route that is slower than other possible routes. Such mistakes by a navigation or mapping service lead to an increased number of accidents, illegal turns, and congestion on roadways. In addition to creating user frustration, multiple mistakes by a digital mapping service will eventually lead to a loss of users. Currently, mapping applications can alter the route to a given location based on real-time traffic and accidents. For example, such information may be collected by GPS and other data. However, such information does not currently correct underlying mistakes in a digital map.

### BRIEF SUMMARY

One aspect of the disclosure provides for correcting mistakes in map information using paths traveled by local drivers. Updates to the map information may be made in real time, as the local user is traveling.

A method provides for determining, with one or more computing devices, a user's level of knowledge of navigating a given area, and receiving, with the one or more computing devices, route input from the user indicating a route of travel within the given area. The method further includes detecting, with the one or more computing devices, variations between the user route input and map information for the given area. For detected variations, it is determined, with the one or more computing devices and based on the user's level of knowledge of navigating the given area, whether to update the map information for the given area using the route input from the user. According to some examples, determining the user's level of knowledge comprises computing a knowledge score for the user. In this regard, the user input route may be weighted based at least in part on the knowledge score. The user route input may be received by, for example, determining a path traveled by the user.

Another aspect of the disclosure provides a system comprising a database storing map information and one or more processors in communication with the map information. The one or more processors are configured to determine a user's level of knowledge of navigating a given area, receive route input from the user indicating a route of travel within the given area, detect variations between the user route input and map information for the given area, and for detected variations, determine, based on the user's level of knowledge of navigating the given area, whether to update the map information for the given area using the route input from the user.

Yet another aspect of the disclosure provides a non-transitory computer-readable medium storing instructions executable by one or more processors for performing a method. This method comprises determining a user's level of knowledge of navigating a given area, receiving route input from the user indicating a route of travel within the given area, detecting variations between the user route input and map information for the given area, and for detected variations, determining, based on the user's level of knowledge of navigating the given area, whether to update the map information for the given area using the route input from the user.

### BRIEF DESCRIPTION OF THE DRAWINGS

FIG. 1 is a functional diagram of a system in accordance with an embodiment.

FIG. 2 is a pictorial diagram of the system of FIG. 1.

FIG. 3 illustrates an example of comparing local driver input to map information in accordance with an embodiment.

FIG. 4 illustrates another example of comparing local driver input to map information in accordance with an embodiment.

FIG. 5 illustrates another example of comparing local driver input to map information in accordance with an embodiment.

FIG. 6 illustrates an example database associated with updating map information in accordance with an embodiment.

FIG. 7 is an example screenshot of a navigation interface in accordance with an embodiment.

FIG. 8 is a flow diagram illustrating an example method in accordance with an embodiment.

### DETAILED DESCRIPTION

The present disclosure relates to a system and method for determining whether a given user is a local or knowledgeable driver of a given area and using their driving habits, routes and other factors to improve mapping recommendations in real-time. For example, paths traveled within the given area by a driver are weighted based on the driver's level of knowledge of the given area. Based on the weight, the paths traveled by the driver may be used to update map information, replace suggested routes of travel, or the like.

To determine whether a given user is a local driver of a given area, the system computes a knowledge score. The knowledge score is based on one or more factors, such as locations stored in a navigation device, locations frequently entered as destinations in a navigation device, locations frequently visited, routes frequently traveled, etc.

The system receives route input from users. For example, a user may manually input a route into a navigation device. According to another example, the input may be passive. For example, the system may detect routes or segments of routes traveled by users.

The system further determines variations between the user input and suggested navigation routes. For example, the navigation device may provide a suggested route between point A and point B. However, the system may detect that the user always makes three right turns at one segment of the route instead of making a left turn as suggested by the navigation device. In some examples, the system may flag that segment of the route for further review. For example, the system may consider driving habits of other drivers along the same segment of the route, or may consult other sources of map or traffic information. In another example, a person may be sent to the location to investigate whether the suggested left turn is a one-way street, whether left turns are forbidden at that segment, etc.

In some instances, the user route input may be used to establish a route that is provided to other users. For example, the user input route may be preferable to the suggested route, such as by being faster, less congested, more accurate, or the like. The system determines whether to modify the suggested route with the user route input based at least in part on the computed knowledge score for the user for the given area. For example, if the user has a high knowledge score for the area, such as above a predetermined threshold, the user is likely to know the quickest or shortest routes in the area. Accordingly, the system may provide the user input route to other users in response to future requests for directions in the area. In doing so, the system may, for example, replace the suggested route with the user route input, or provide the user input route as a preferred option to the suggested route.

According to some examples, the system may further compute a speed score for the user. The speed score may also be used in the determination of whether to modify the suggested route with the user route input. For example, the system may determine that the user typically drives approximately 10 miles per hour over the speed limit. If the user traveled the user input route faster than the approximate time for traveling the suggested route, the system may use the user's speed score to offset the time difference.

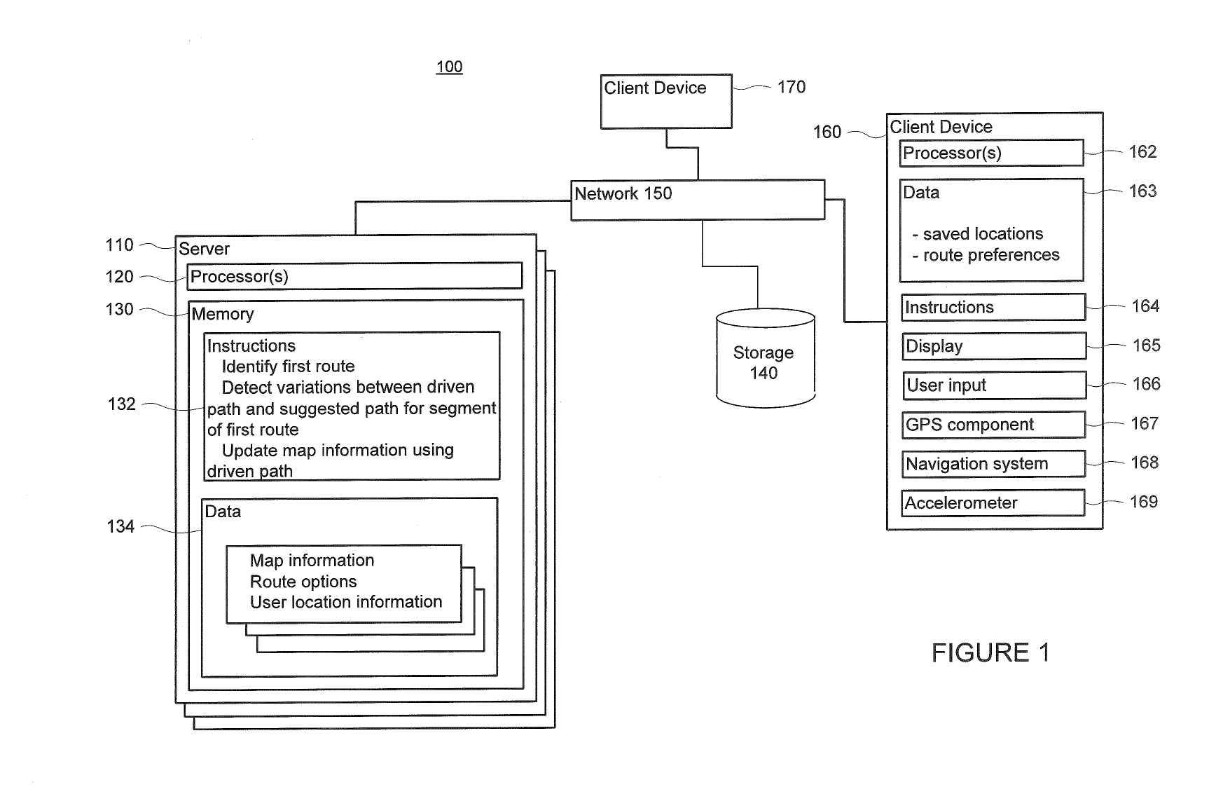

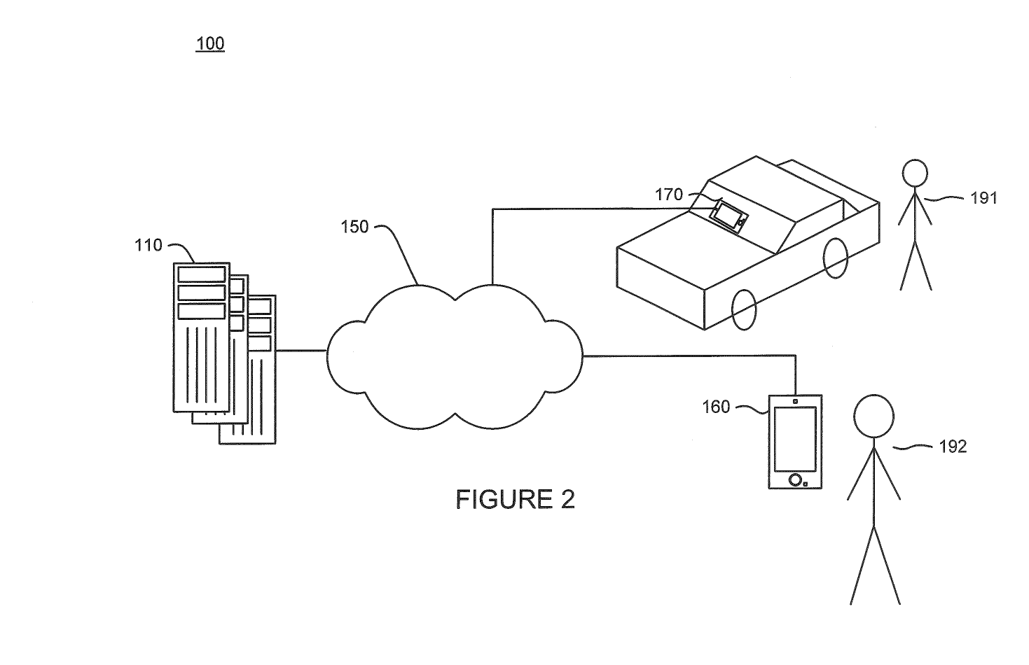

FIGS. 1 and 2 include an example system 100 in which the features described above may be implemented. It should not be considered as limiting the scope of the disclosure or usefulness of the features described herein. In this example, system 100 can include one or more computing devices 110, which may be connected to further computing devices 160 and 170 over a network 150.

Computing devices 110 can contain one or more processors 120, memory 130 and other components typically present in general purpose computing devices. The memory 130 stores information accessible by processor 120, including instructions 132 and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the system and method is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as commercial CPUs for personal computers. Alternatively, the processor may be a dedicated device such as an ASIC. Although FIG. 1 functionally illustrates the processor, memory, and other elements of computer 110 as being within the same block, the processor and memory may actually comprise multiple processors and memories that may or may not be stored within the same physical housing. For example, memory may be a hard drive or other storage media located in a housing different from that of computer 110. Accordingly, references to a processor, computer, computing device, or memory will be understood to include references to a collection of processors, computers, computing devices, or memories that may or may not operate in parallel. For example, the computing devices 110 may include server computing devices operating as a load-balanced server farm, distributed system, etc. Yet further, although some functions described below are indicated as taking place on a single computing device having a single processor, various aspects of the subject matter described herein can be implemented by a plurality of computing devices, for example, communicating information over network 150.

Each of the computing devices 110 can be at different nodes of the network 150 and capable of directly and indirectly communicating with other nodes of network 150. Although only a few computing devices are depicted in FIGS. 1-2, it should be appreciated that a typical system can include a large number of connected computing devices, with each different computing device being at a different node of the network 150. The network 150 and intervening nodes described herein can be interconnected using various protocols and systems, such that the network can be part of the Internet, World Wide Web, specific intranets, wide area networks, or local networks. The network can utilize standard communications protocols, such as Ethernet, WiFi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, each of the computing devices 110 may include web servers capable of communicating with a storage system 140 as well as computing devices 160, 170 via the network 150. For example, one or more of server computing devices 110 may use network 150 to transmit and present information to a user, such as user 191, 192, on a display, such as displays 165 of computing devices 160, 170. In this regard, computing devices 160, 170 may be considered client computing devices and may perform all or some of the features described herein.

Each of the client computing devices 160, 170 may be configured similarly to the server computing devices 110, with one or more processors 162 and memory, including data 163 and instructions 164 as described above. Each client computing device 160, 170 may be a personal computing device intended for use by a user 191, 192 and have all of the components normally used in connection with a personal computing device such as a central processing unit (CPU), memory (e.g., RAM and internal hard drives) storing data and instructions, a display 165 (e.g., a monitor having a screen, a touch-screen, a projector, a television, or other device that is operable to display information), and user input device 166 (e.g., a mouse, keyboard, touch-screen or microphone).

Although the client computing devices 160, 170 may each comprise a full-sized personal computing device, they may alternatively comprise mobile computing devices capable of wirelessly exchanging data with a server over a network such as the Internet. By way of example only, client computing device 160 may be a mobile phone or a device such as a vehicle navigation device, a wireless-enabled PDA, a tablet PC, or a netbook that is capable of obtaining information via the Internet. In another example, client computing device 170 may be a head-mounted computing system. As an example, the user may input information using a small keyboard, a keypad, microphone, using visual signals with a camera, or a touch screen.

Client computing devices 160, 170 may also include a geographic position component 167 in communication with computer 110 for determining the geographic location of the device. For example, the position component may include a GPS receiver to determine the device's latitude, longitude and/or altitude position. Other location systems such as laser-based localization systems, inertial-aided GPS, or camera-based localization may also be used to identify the location of the client device 160, 170. In some examples, the geographic position component 167 may be part of a navigation system 168 installed on the client device 160, 170.

The client device 160, 170 may also include other features in communication with computer 110, such as an accelerometer 169, gyroscope or another direction/speed detection device to determine the direction and speed of the vehicle or changes thereto. By way of example only, such a device may track increases or decreases in speed and the direction of such changes. The device's provision of location and orientation data as set forth herein may be provided automatically to the computer 110.

The data that is provided by the client device 160, 170 may be processed by the computer 110 in real-time. In addition to processing data provided by the client devices 160, 170, the computer 110 may rely on environmental data that was obtained at a previous point in time. For example, data 134 may include detailed map information, e.g., highly detailed maps identifying the shape and elevation of roadways, lane lines, intersections, crosswalks, speed limits, traffic signals, buildings, signs, real time traffic information, or other such objects and information. For example, the map information may include explicit speed limit information associated with various roadway segments. The speed limit data may be entered manually or scanned from previously taken images of a speed limit sign using, for example, optical-character recognition. The map information may include three-dimensional terrain maps incorporating one or more of objects listed above.

The storage system 140 can be of any type of computerized storage capable of storing information accessible by the server computing devices 110, such as a hard-drive, memory card, ROM, RAM, DVD, CD-ROM, write-capable, and read-only memories. In addition, storage system 140 may include a distributed storage system where data is stored on a plurality of different storage devices which may be physically located at the same or different geographic locations. Storage system 140 may be connected to the computing devices via the network 150 as shown in FIG. 1 and/or may be directly connected to any of the computing devices 110, 160, 170.

Storage system 140 may store map information, such as an image-based map, raster-based map, or any other type of map information. For example, the map information may include one or more roadgraphs or graph networks of information such as roads, lanes, intersections, and the connections between these features. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

Using the system described above, knowledge of local drivers may be used to update map information. To determine whether a driver is a local to a given area, the system may consider information provided by the driver, such as addresses designated as “home” or “work”, destinations frequently visited, routes frequently traveled, locations where the client device typically remains stationary for prolonged periods of time, or other information.

According to one example, the system computes a knowledge score for the driver using the information provided. By way of example only, one or more points are attributed to each factor indicating that a driver is a local. The factors may be, for example, stored locations, locations frequented, frequently traveled routes, or the like. In this regard, a driver that travels within a given area every day will have a higher knowledge score than a driver that visited a destination in the given area one time.

If the driver is determined to be a local, the driver's actions may be used to update map information. For example, paths traveled by the local driver are compared to segments of predetermined routes. Where the local driver's path differs from the predetermined route segment, the predetermined route segment may be flagged as potentially inaccurate or less preferable.

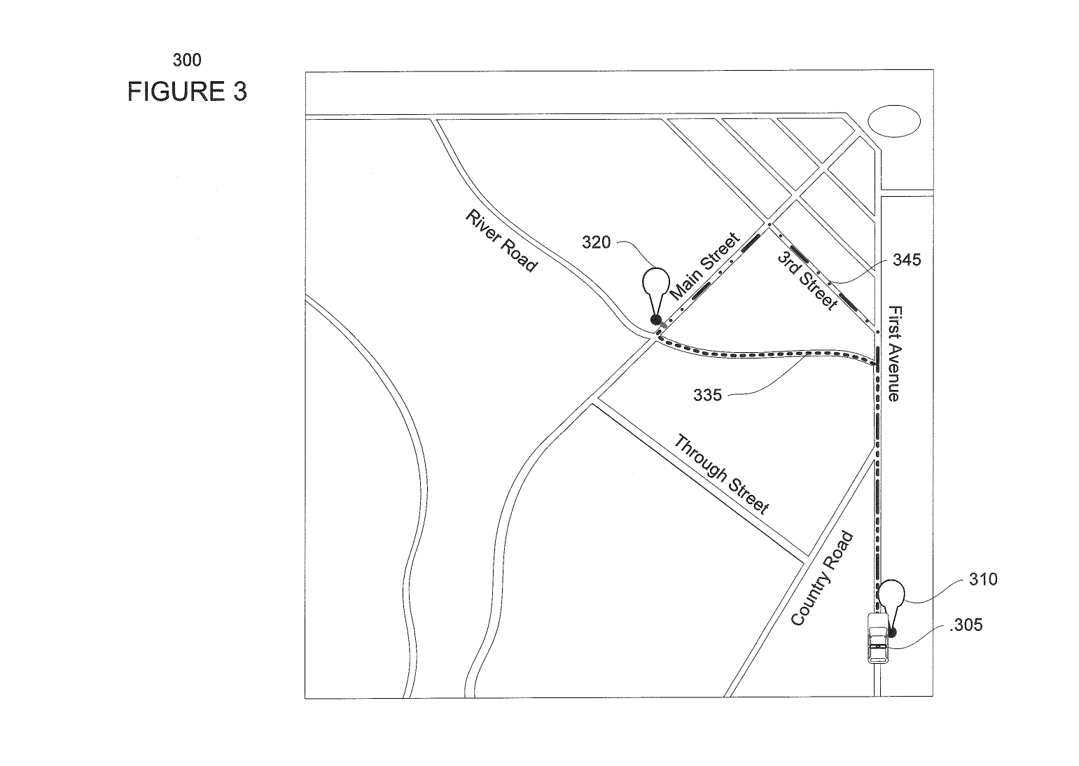

FIG. 3 illustrates an example of comparing a local driver's paths to predetermined routes. For example, route 335 may be identified by a navigation system as the best (e.g., shortest, fastest, etc.) route between starting point 310 and destination 320. However, the system may detect that local driver 305 always travels along alternate route 345. There may be any number of reasons for taking alternate route 345, such as if River Road is a one-way street heading East, left turns onto River Road from First Avenue are prohibited (e.g., by law, median, or otherwise), or traffic heading West on River Road is heavy at the time the local driver is traveling. Accordingly, in one example the system may flag the segment of the route 335 including River Road for further review. In reviewing the segment, a person may be sent to the site to investigate, other map sources may be consulted, requests for user feedback may be sent, or any other mechanism may be used. If an inaccuracy in the map information is detected, such as an impossible left turn or a one-way street, the map information may be updated to correct it.

In another example, paths traveled by other local drivers may be considered and compared to the route 335 and/or the route 345. If most or all knowledgeable drivers travel along alternative route 345, mapping information may be updated to identify the route 345 in response to future requests for directions.

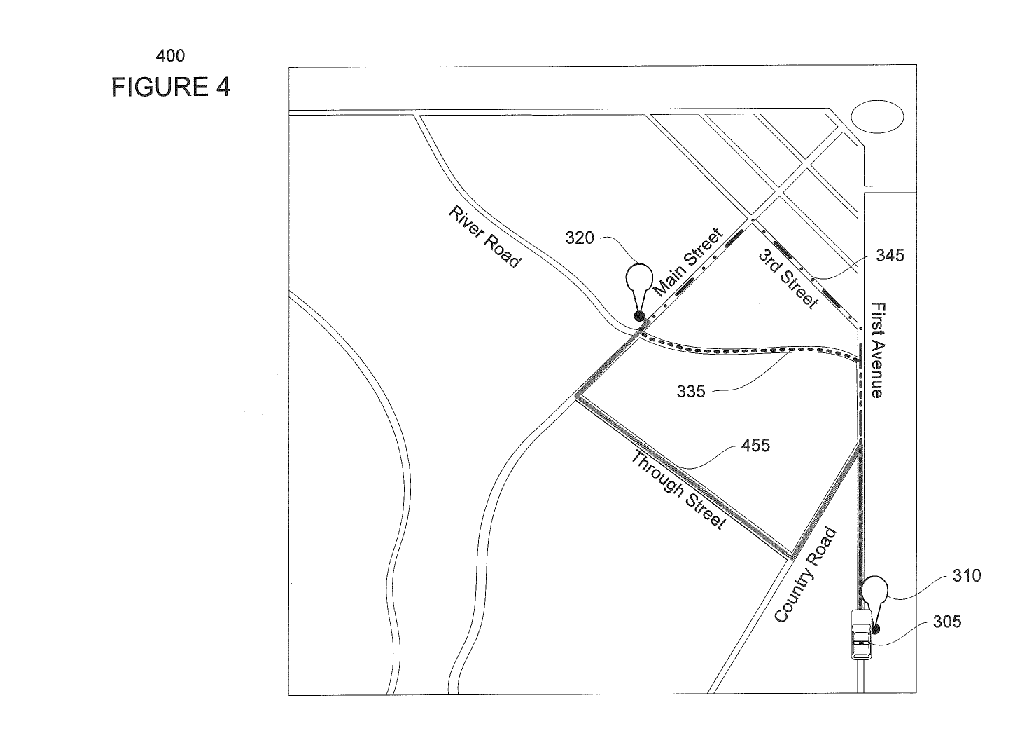

According to some examples, the local driver's path may be weighted based on the driver's knowledge score. For example, referring to FIG. 4, it may be detected that a second driver usually travels a second alternative route 455, which also avoids River Road. The second driver, however, may have a lower knowledge score than the first local driver. In this regard, when determining which alternative route to suggest to future users requesting directions, the system may select the alternative route 345 because it is associated with the more knowledgeable driver.

Other factors may be considered also in addition to the driver's knowledge score in determining whether to update map information. For example, it may be detected that the knowledgeable driver 305 travels the alternative route 345 at some times, but travels the identified route 335 at other times. This may be an indication of heavy traffic or time-based driving restrictions (e.g., no left turns between 7 a.m. and 9 a.m. on school days). Accordingly, the map information may also be updated with such timing information. In this regard, the system may suggest the route 335 to future users at some times, while suggesting the route 345 at other times.

Timing information may also be used to determine how quickly a knowledgeable driver travels a given path. For example, the driver 305 may travel the alternate route 345 in minutes, while the route 335 is estimated to take 10 minutes. In some examples, such timing information may be used to determine if one route or segment of a route is preferable to another. Such timing information may also be used to update map information.

Yet another factor that may be considered is the knowledgeable driver's speed. Such speed may be detected using, for example, GPS, accelerometers, or other information transmitted from the driver's vehicle or mobile device to the one or more servers. The speed information may be used, for example, to determine whether the knowledgeable driver's route is actually faster than a previously identified route, or whether it was only traveled faster by the knowledgeable driver because he was speeding.

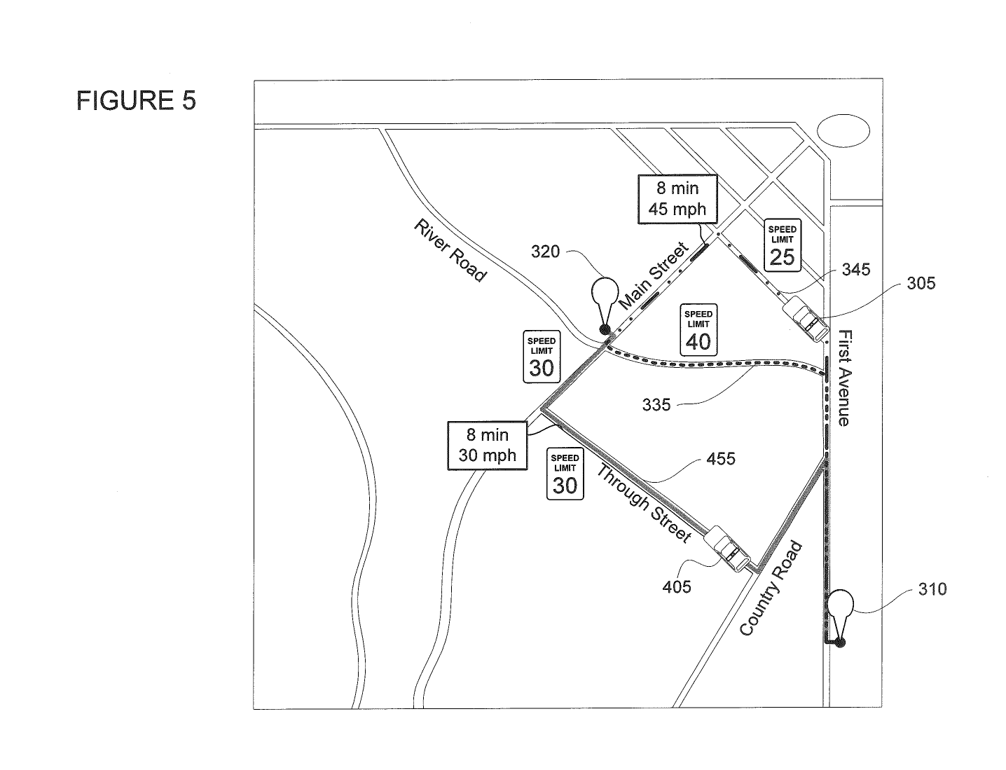

FIG. 5 illustrates an example of using the knowledgeable driver's speed information. As shown, first knowledgeable driver 305 travels the alternate route 345 in 8 minutes. However, the driver 305 was traveling at approximately 45 mph, which is 20 mph over the posted speed limit on that route. The second knowledgeable driver 405 traveled the alternate route 455 also in 8 minutes, but traveled at the posted speed limit. In this example, the alternate route 455 may be determined to be faster. For example, the system may offset the actual travel time based on the driver's speed to compute an estimated travel time for the route 345 at the speed limit.

According to one example, the system may calculate a speed score for drivers for the given area. For example, the speed score may be based on an average rate of speed traveled by the driver in the relation to the speed limits. In this regard, the determination of whether to update the mapping information with the driver's path may be based in part on the driver's aggregate speed score.

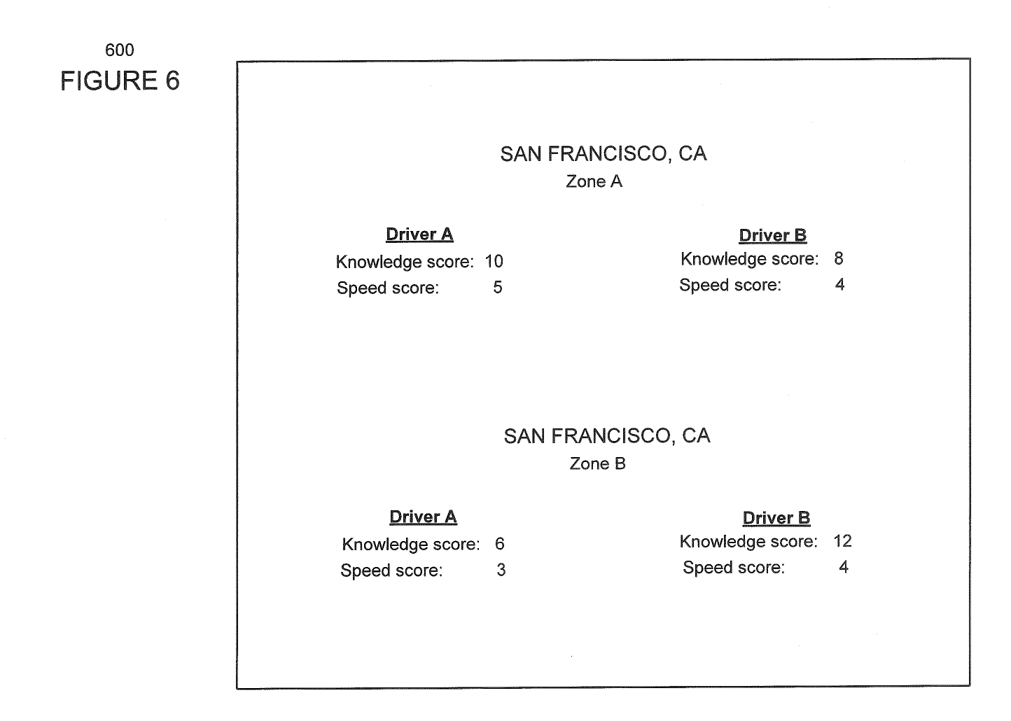

FIG. 6 illustrates an example of a database storing profile information for drivers. The profile information may only be maintained for drivers who have set their mobile or navigation device to enable the provision of such information. For example, the drivers may elect to participate in providing information associated with their driving habits to be used for updating mapping information. No personal data is required. The profile information may store, for each participating driver, the knowledge score and the speed score associated with a particular area. The knowledge and speed scores will vary based on the area and the driver's activity within that area.

While FIG. 6 illustrates the areas as being divided into different zones, with a different set of scores stored for each zone, it should be understood that the data associating the participating driver's activity with the areas may be stored in any of a number of ways. For example, each driver may be associated with an area within a predetermined radius of a particular location. Moreover, only profiles for a driver with a knowledge score above a predetermined value may be stored.

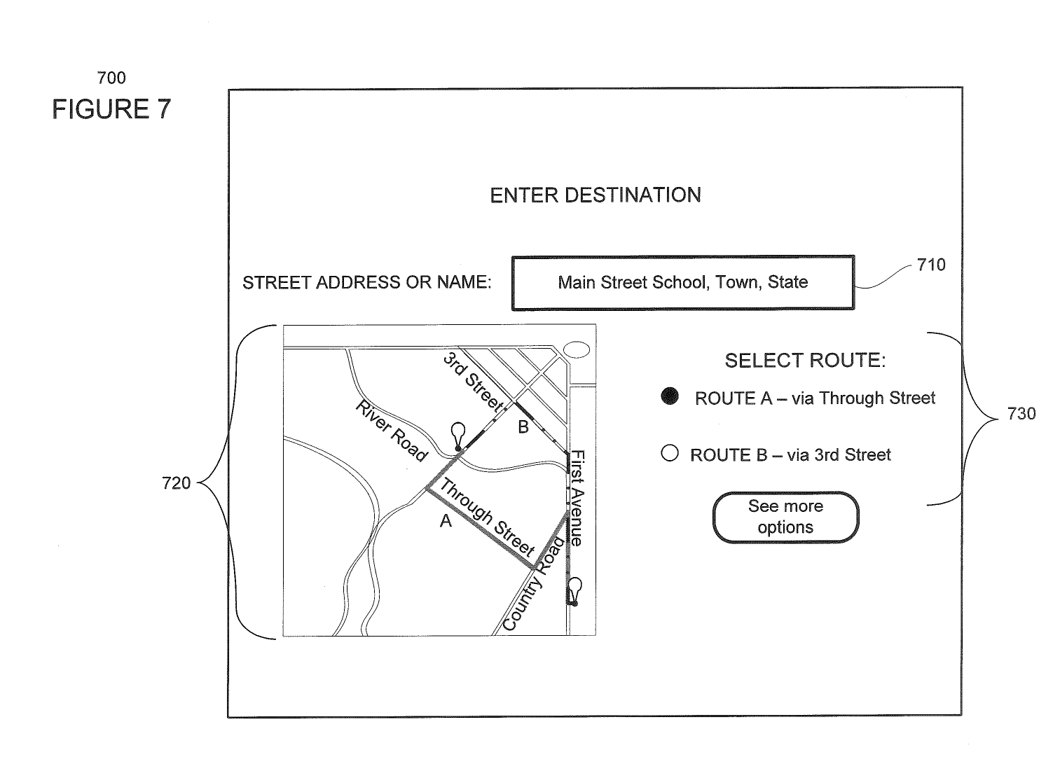

Using the updated mapping information based on the knowledgeable driver's input, the system may provide future users with better (e.g., faster, more accurate, etc.) route options for traveling within a given area. FIG. 7 illustrates an example screenshot of a navigation device providing the options to a future user based on the knowledgeable driver's input. As shown, for a destination entered in field 710, the system generates a map 720 indicating the potential routes. The system also provides route selection options 730. These options may be presented in an order based on information received from knowledgeable drivers traveling those routes. For example, using the timing, speed, and other information, a fastest route may be presented as a first option. These options may change depending on the time of day to account for traffic, time-based driving restrictions, etc.

According to one example, the mapping information updates may be processed immediately upon receipt of information from a knowledgeable driver. For example, as the knowledgeable driver is traveling along a route, variations from a segment of a suggested route are detected, and the mapping information corresponding to that segment of the route is updated. In other examples, the information from knowledgeable drivers is aggregated and the mapping information is updated periodically, such as hourly, daily, weekly, etc.

While the foregoing examples have been described with respect to routes traveled by knowledgeable drivers, it should be understood that the same concepts may be applied to segments of routes. For example, referring back to FIG. 5, information from a knowledgeable driver regarding a left turn off of First Avenue may be used to update map information, although the knowledgeable driver's ultimate destination can vary greatly from other users' destinations. Moreover, the knowledgeable driver need not enter the route into a navigation device to provide the route information. For example, a driver that has elected to participate in providing information may not require guidance from a navigation device to travel to work every day, but may nevertheless provide information relating to the route traveled.

Further, while the foregoing examples describe knowledgeable drivers providing input by way of driving habits detected by the system, it should be understood that the knowledgeable drivers can alternatively or additionally provide input manually. By way of example only, the driver can modify a segment of a route provided by the driver's navigation device using a touchscreen.

In addition to the operations described above and illustrated in the figures, various operations will now be described. It should be understood that the following operations do not have to be performed in the precise order described below. Rather, various steps can be handled in a different order or simultaneously, and steps may also be added or omitted.

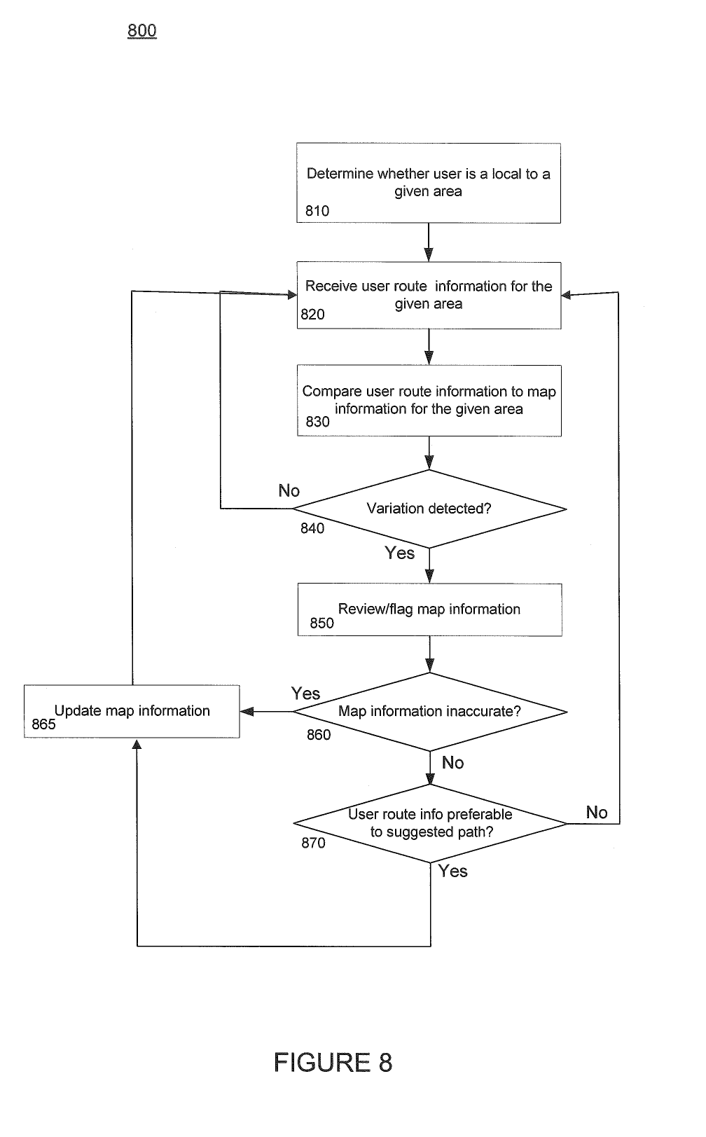

FIG. 8 provides a flow diagram illustrating an example method. According to this method, route information from local or knowledgeable drivers is used to update map information. The method may be performed by, for example, a client device (e.g., a mobile phone, navigation device, etc.), one or more server computers, or a combination of such devices communicating over a network. While in this example a user is providing particular information, no personal data need be transmitted, and privacy protections are provided for the user data including, for example, anonymization of personally identifiable information, aggregation of data, filtering of sensitive information, encryption, hashing or filtering of sensitive information to remove personal attributes, time limitations on storage of information, or limitations on data use or sharing.

In block 810, it is determined whether a user is a local to a given area. For example, a knowledge score for the user for the given area may be computed. The determination can be based on, for example, a proximity of the given area to addresses saved by the user, the user's travel time within the given area, the user's time spent at locations within the given area, etc.

In block 820, user route information for the given area is received. According to one example, the user route information may be paths of travel taken by the user and detected by one or more devices or computing systems. For example, referring to FIG. 4, it may be detected that the user drove North on First Avenue and turned left on 3rd Street. Such information may be collected over a period of time and aggregated, for example, to determine whether the user always takes such path or if it is an isolated occurrence. Moreover, the route information received may include other information such as timing and speed information. In this regard, it may be determined that the user travels North on First Avenue and turns left on 3rd Street on weekdays between 3 p.m. and 6 p.m., but otherwise turns left on River Road. According to other examples, the user may provide route information manually, such as through a user interface of a mobile device.

In block 830, the received user route information is compared to map information for the given area. The map information may include road markers, lane markers, directional information (e.g., whether streets are one-way or two-way), traffic information, speed limits, legal restrictions (e.g., whether U-turns or left turns are prohibited), or any other information relating to travel within the given area. In one example, comparing the received user route to the map information may include identifying paths of travel within the given area that would be suggested based on current map information, and comparing those identified paths with the user route information. For example, referring to FIG. 4, the route 335 may be identified as a route that would have been suggested, and compared to the routes 345 and 455 that were actually taken by knowledgeable drivers.

In block 840, it is determined whether variations between the received user route information and the map information are detected. The variations may be based on any aspect of the map information, such as directional information, legal restrictions, or the like. For example, referring back to FIG. 4, if the user route information indicates that the user traveled North on First Avenue and turned left on 3rd Street, but the current map information indicates that left turns onto 3rd Street are prohibited (e.g., by law, a median, or otherwise), this variation between the two sets of information will be detected.

If no variations are detected in block 840, the process returns to block 820. However, if a variation is detected, the process proceeds to block 850, where the map information is flagged and/or reviewed. For example, referring back to FIG. 4, if it determined based on the comparison that the knowledgeable driver does not turn left on River Road, and instead turns on 3rd Street, the segment of the map including River Road may be flagged for review. Accordingly, someone may be sent to the site to investigate. Alternatively or additionally, other sources may be consulted and compared with the map information, such as other knowledgeable driver's habits, other map information, imagery, etc.

In block 860, it is determined whether the current map information is inaccurate. Such determination may be based on, for example, the received user route input and/or the review of the map information. If it is determined that the map information includes an inaccuracy, the map information is updated in block 865 to correct the inaccuracy. However, if the map information is not inaccurate, the process proceeds to block 870.

In block 870, it is determined whether the user route information is preferable to a path that would have been suggested by a navigation system based on the current map information. For example, it may be determined whether the user route is faster, has less traffic, or has other qualities in comparison to the route that would have been suggested. In making this determination, a speed of the local user may be considered. For example, a speed score may be determined for the user and factored into the comparison of the user route with the would-have-been-suggested route to determine whether the local user's route is actually faster, or if the local user was only able to travel the route more quickly because he was speeding.

If the user route information is preferable to the suggested route, the process proceeds to block 865, where the map information is updated. In this instance, the map information is updated to reflect that the user route is preferable to the would-have-been-suggested route. For example, the map information is updated with regard to timing information, traffic information, or any other information associated with the determination of why the user route is preferable.

While the foregoing examples have been described in connection with drivers driving on a road, it should be understood that the subject matter is also applicable to other forms of travel, such as walking, cycling, or the like.

The subject matter described herein is advantageous in that it provides for automatically updating map information. In this regard, the map information is current and accurate. Moreover, because the updates are based on user input, a cost associated with the update is relatively low.

As these and other variations and combinations of the features discussed above can be utilized without departing from the subject matter as defined by the claims, the foregoing description of embodiments should be taken by way of illustration rather than by way of limitation of the subject matter as defined by the claims. It will also be understood that the provision of the examples described herein (as well as clauses phrased as “such as,” “e.g.”, “including” and the like) should not be interpreted as limiting the claimed subject matter to the specific examples; rather, the examples are intended to illustrate only some of many possible aspects.

1. A method comprising:
determining, with one or more computing devices, a user's level of knowledge of navigating a given area;
receiving, with the one or more computing devices, route input from the user indicating a route of travel within the given area;
detecting, with the one or more computing devices, variations between the user route input and map information for the given area;
for detected variations, determining, with the one or more computing devices and based on the user's level of knowledge of navigating the given area, whether to update the map information for the given area using the route input from the user.

2. The method of claim 1, wherein determining the user's level of knowledge comprises computing a knowledge score for the user.

3. The method of claim 2, further comprising weighting the user input route based at least in part on the knowledge score.

4. The method of claim 1, further comprising
computing, using the one or more computing devices, a speed score associated with the user;
wherein the determining whether to update the map information for the given area using the route input from the user is further based on the computed speed score.

5. The method of claim 1, wherein receiving the route input from the user comprises determining a path traveled by the user.

6. The method of claim 5, wherein the determining whether to update the map information for the given area using the route input from the user is performed while the user is traveling the path.

7. The method of claim 1, further comprising flagging for review portions of the map information for which variations from the user input route were detected.

8. The method of claim 7, further comprising comparing at least one of the flagged portion of the map information and the user route input with a secondary source, wherein the secondary source includes one of input from other drivers having a predetermined level of knowledge of the given area, and imagery of the given area.

9. A system comprising:
a database storing map information; and
one or more processors in communication with the map information, the one or more processors to:
determine a user's level of knowledge of navigating a given area;
receive route input from the user indicating a route of travel within the given area;
detect variations between the user route input and map information for the given area;
for detected variations, determine, based on the user's level of knowledge of navigating the given area, whether to update the map information for the given area using the route input from the user.

10. The system of claim 9, wherein determining the user's level of knowledge comprises computing a knowledge score for the user.

11. The system of claim 10, wherein the one or more processors are further configured to weight the user input route based at least in part on the knowledge score.

12. The system of claim 9, wherein the one or more processors are further configured to compute a speed score associated with the user, wherein the determining whether to update the map information for the given area using the route input from the user is further based on the computed speed score.

13. The system of claim 9, wherein receiving the route input from the user comprises determining a path traveled by the user.

14. The system of claim 13, wherein the determining whether to update the map information for the given area using the route input from the user is performed while the user is traveling the path.

15. The system of claim 9, wherein the one or more processors are further configured to flag for review portions of the map information for which variations from the user input route were detected.

16. The system of claim 15, wherein the one or more processors are further configured to compare at least one of the flagged portion of the map information and the user route input with a secondary source, wherein the secondary source includes one of input from other drivers having a predetermined level of knowledge of the given area, and imagery of the given area.

17. A non-transitory computer-readable medium storing instructions executable by one or more processors for performing a method comprising:
determining a user's level of knowledge of navigating a given area;
receiving route input from the user indicating a route of travel within the given area;
detecting variations between the user route input and map information for the given area;
for detected variations, determining, based on the user's level of knowledge of navigating the given area, whether to update the map information for the given area using the route input from the user.

18. The non-transitory computer-readable medium of claim 17, the method further comprising:
computing a knowledge score for the user; and
weighting the user input route based at least in part on the knowledge score.

19. The non-transitory computer-readable medium of claim 17, wherein receiving the route input from the user comprises determining a path traveled by the user.

20. The non-transitory computer-readable medium of claim 17, the method further comprising computing, using the one or more computing devices, a speed score associated with the user; wherein the determining whether to update the map information for the given area using the route input from the user is further based on the computed speed score.
